(19) United States
(12) Patent Application Publication
(10) Pub. No.: US 2019/0240990 A1
(43) Pub. Date: Aug. 8, 2019

(54) PRINTER

(71) Applicant: TOSHIBA TEC KABUSHIKI KAISHA, Tokyo (JP)

(72) Inventor: Yasuhiro SEKI, Mishima Shizuoka (JP)

(21) Appl. No.: 16/266,391

(22) Filed: Feb. 4, 2019

(30) Foreign Application Priority Data
Feb. 8, 2018 (JP) 2018-021332

(51) Int. Cl. B41J 2/325; B41J 29/38

(52) U.S. Cl. CPC B41J 2/325; B41J 29/38

(57) ABSTRACT

A printer includes a line-shaped print head configured to transfer ink held on an ink ribbon onto a print medium, a platen configured to convey the print medium and the ink ribbon such that the print medium and the ink ribbon are sandwiched between the platen and the print head, a first sensor configured to detect a width of the print medium, a second sensor configured to detect a width of the ink ribbon, a display, and a processor configured to determine whether the width of the ink ribbon detected by the second sensor exceeds a maximum width, which is set in accordance with the width of the print medium detected by the first sensor, and control the display to display a message indicating that the ink ribbon is not appropriate when it is determined that the width of the ink ribbon exceeds the maximum width.

### CROSS-REFERENCE TO RELATED APPLICATION

This application is based upon and claims the benefit of priority from Japanese Patent Application No. 2018-021332, filed on Feb. 8, 2018, the entire contents of which are incorporated herein by reference.

### FIELD

Embodiments described herein relate generally to a printer.

### BACKGROUND

A conventional printer, such as a label printer or a receipt printer, which draws out an accommodated roll of paper to perform printing thereon, transfers ink applied to an ink ribbon onto a paper using a print head, such as a thermal head. In such a printer, the paper and the ink ribbon are sandwiched between the print head and a columnar platen for conveying the paper in the same direction as the platen rotates, and meanwhile, the print head performs printing on the paper. Specifically, the head and the platen sandwich the paper and the ink ribbon in such a manner that the platen contacts the paper and the print head contacts the ink ribbon.

In such a printer, an ink ribbon whose width is wider than a width of the paper is generally used for printing an image from one end to the other end of the paper in a width direction of the paper. Therefore, the print head and the platen sandwich the paper and the ink ribbon in an overlapped manner at a position where the paper and the ink ribbon overlap with each other, and sandwich only the ink ribbon at positions of both ends where there is only the ink ribbon without paper.

Therefore, a distance from the rotational axis of the platen to the ink ribbon at the position where the paper and the ink ribbon are overlapped with each other is longer than a distance from the rotational axis of the platen to the ink ribbon at the position where there is only the ink ribbon, by a thickness of the paper. Therefore, a conveyance speed of the ink ribbon by the platen is faster at the position where the paper and the ink ribbon are overlapped with each other than the position where there is only the ink ribbon. Therefore, if an ink ribbon whose width is extremely wider than the width of the paper is used, the ink ribbon may wrinkle due to a difference between the conveyance speed of the ink ribbon at the position where the paper and the ink ribbon are overlapped with each other and the conveyance speed of the ink ribbon at the position where there is only the ink ribbon. When the printing is performed on the paper using the ink ribbon having wrinkles, unevenness in printing may occur between a wrinkled portion and the other portion in some cases.

### DESCRIPTION OF THE DRAWINGS

FIG. 1 is a perspective view of a printer according to an embodiment;

FIG. 2 is a side sectional view schematically illustrating an internal structure of the printer;

FIG. 3 is a diagram illustrating a positional relationship between a label paper and a paper width detection sensor in the printer, and a positional relationship between an ink ribbon and a ribbon width detection sensor;

FIG. 4 is a block diagram illustrating a hardware configuration of the printer;

FIG. 5 is a table associating paper widths with appropriate ribbon widths;

FIG. 6 is a functional block diagram of the printer;

FIG. 7 is a flowchart of a control processing executed by the printer;

FIG. 8 is a flowchart of a control processing executed by the printer; and

FIG. 9 is a diagram illustrating an example of a message displayed by the printer.

### DETAILED DESCRIPTION

In accordance with an embodiment, a printer includes a line-shaped print head configured to transfer ink held on an ink ribbon onto a print medium, a platen configured to convey the print medium and the ink ribbon such that the print medium and the ink ribbon are sandwiched between the platen and the print head, a first sensor configured to detect a width of the print medium, a second sensor configured to detect a width of the ink ribbon, a display, and a processor configured to determine whether the width of the ink ribbon detected by the second sensor exceeds a maximum width, which is set in accordance with the width of the print medium detected by the first sensor, and control the display to display a message indicating that the ink ribbon is not appropriate when it is determined that the width of the ink ribbon exceeds the maximum width.

Hereinafter, a printer according to an embodiment is described in detail with reference to the accompanying drawings. In the embodiments described below, a label paper is described as an example of a print medium. In the embodiments described below, a thermal printer is described as an example of a printer. The present invention is not limited by the embodiments described below.

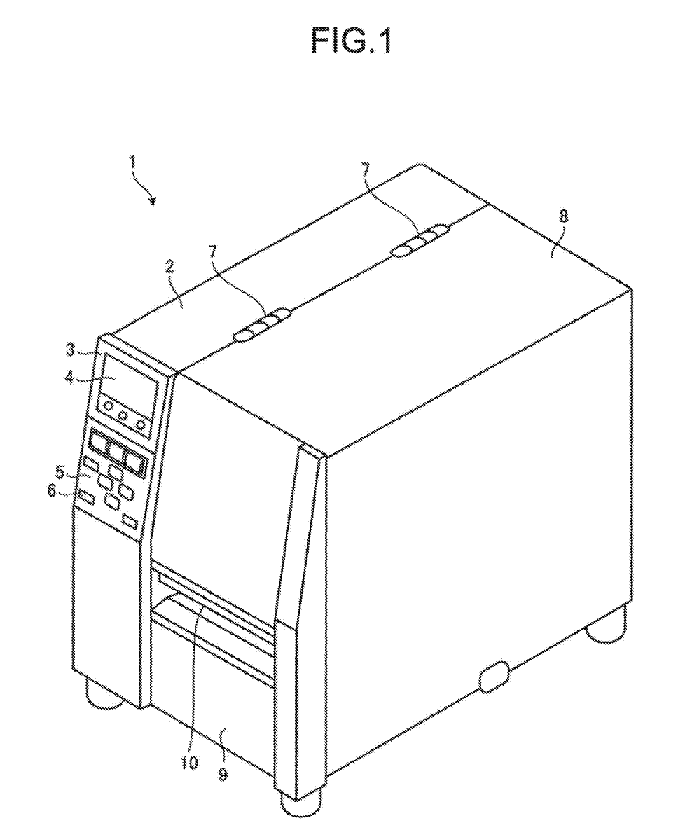

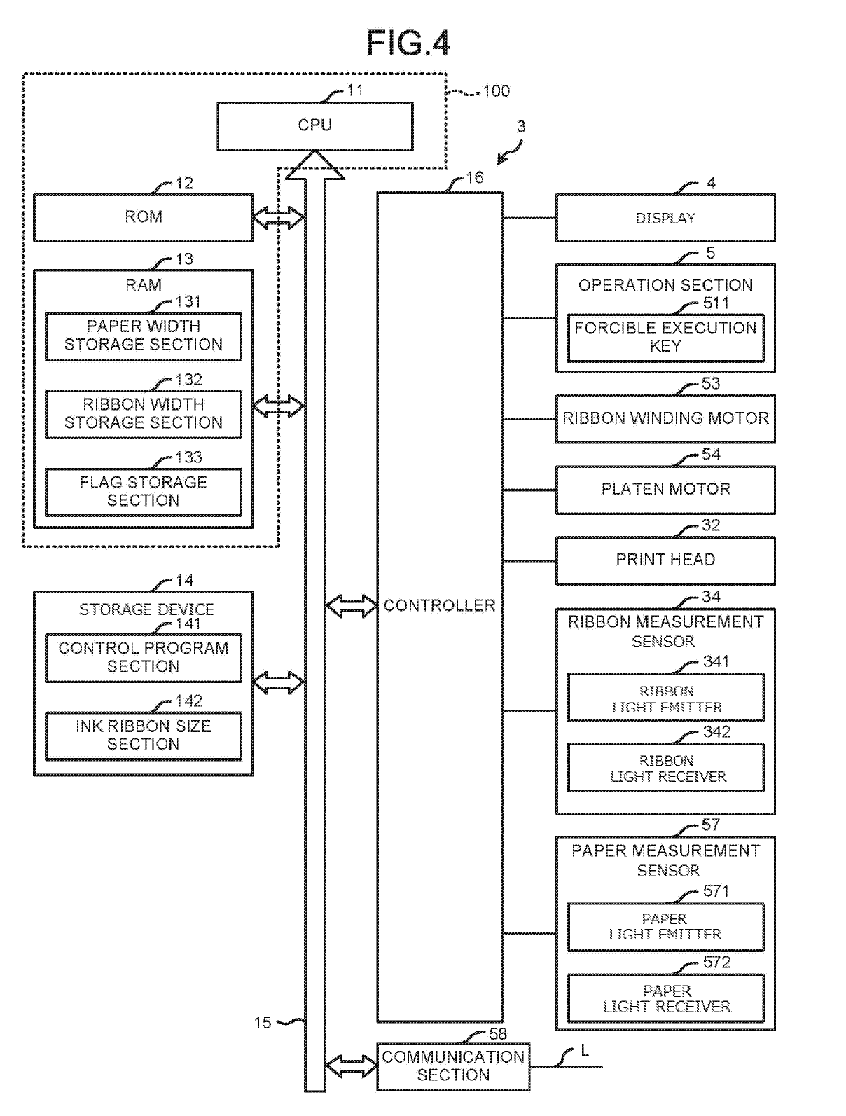

FIG. 1 is a perspective view of a printer 1 according to an embodiment. As shown in FIG. 1, the printer 1 includes a casing 2 on the left side, and a casing 8 connected to the right side of the casing 2 via a hinge 7. A front panel 3 of the casing 2 has a display 4 and an input device 5. The display 4 is a liquid crystal display attached with a backlight, but other types of display devices may be used as the display 4. The input device 5 includes a plurality of operation buttons 6 including a forcible execution key 511 (refer to FIG. 4) and a power button (not shown).

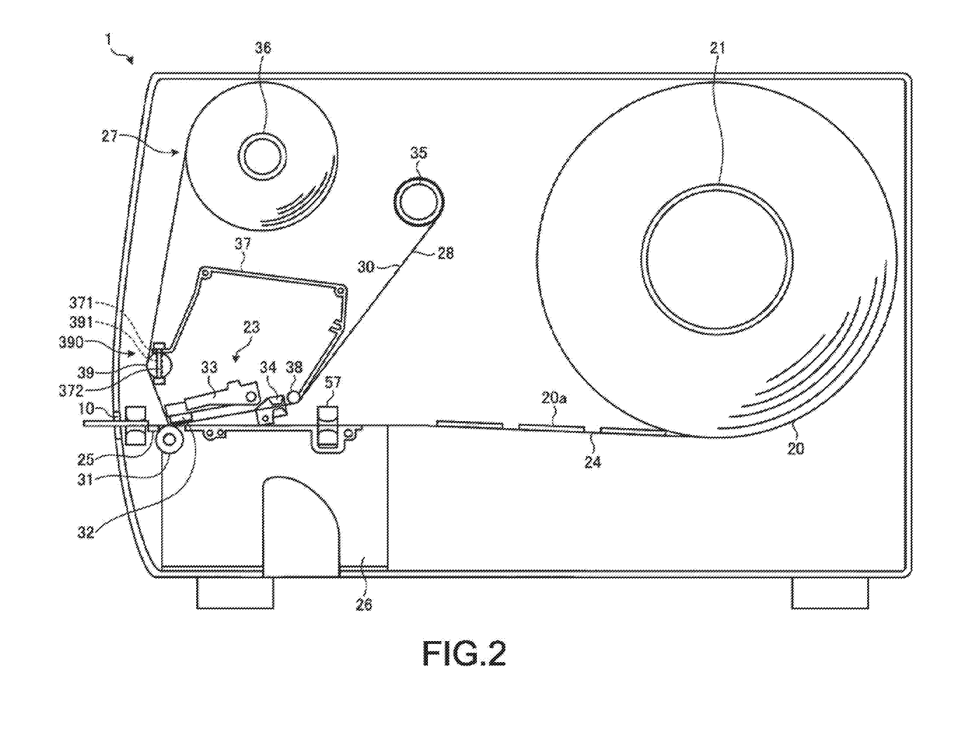

The casing 8 on the right side can largely open the inside of a housing (i.e., the casings 2 and 8) from a side surface side by pivoting about the hinge 7. As described later with reference to FIG. 2, the printer 1 has a label paper 20 wound in a roll shape, an ink ribbon 30 stretched around two shafts, and a printing section 23 for performing printing on the ink ribbon 30 in the housing. Therefore, by pivoting the casing 8 about the hinge 7 to raise the casing 8 towards an upper portion, it is easy to replace the ink ribbon 30 and the label paper 20 or to facilitate internal maintenance. In a front panel 9 of the casing 8, a label issuing port 10 is provided. The printer 1 issues a label after printing from the label issuing port 10.

FIG. 2 is a side sectional view schematically illustrating an internal structure of the printer 1. As shown in FIG. 2, the printer 1 mainly includes a paper holding section 21, the printing section 23, a frame 26 and an ink ribbon supply device 27 in the housing thereof.

The paper holding section 21 is a shaft for holding the label paper 20 wound in a roll shape together with a mount. The label paper 20 is pulled out from the paper holding section 21, and finally discharged from the label issuing port 10 after printing by the printing section 23. The label paper 20 may be a label paper formed by affixing a label 20a to the mount.

The conveyance path 24 is a path along which the label paper 20 pulled out from the paper holding section 21 is conveyed to positions of a print head 32 and a platen 31 described later. The conveyance path 24 has a paper measurement sensor 57 is installed for measuring a length in a width direction of the label paper 20 pulled out (i.e., the length in the direction orthogonal to the conveyance direction of the label paper 20). The paper measurement sensor 57 is positioned between a position where the label paper 20 is pulled out and a position where the print head 32 and the platen 31 described later are arranged in the conveyance path 24.

In the conveyance path 24, a label peeling plate 25 is provided on the downstream side of the printing section 23 in a conveyance direction. The label peeling plate 25 bends the mount of the label paper 20 being conveyed at an acute angle to separate the label 20a and the mount from each other. The mount is wound around a winding shaft (not shown), and on the other hand, the label 20a peeled from the mount is issued from the label issuing port 10.

The printing section 23 mainly includes the print head 32 which is a line type thermal printer in which heat generating elements are arranged in a line in a direction substantially orthogonal to the conveyance direction of the ink ribbon 30 and the label paper 20 (i.e., in the width direction of the ink ribbon 30 and the label paper 20). The platen 31 having a cylindrical shape is rotatably attached to the frame 26, and is rotated when being driven by a platen motor 54 described later in FIG. 4.

The print head 32 is fixed to a head holding portion 33 rotatably attached to a frame (not shown). The print head 32 is energized in a direction to be pressurized towards the platen 31 as the head holding portion 33 rotates to abut against or separate from the platen 31. The printer 1 has a head lifting mechanism for lifting the print head 32, and a head abutting mechanism for enable the print head 32 to abut against the platen 31 (neither is shown). When the head lifting mechanism operates, the print head 32 separates from the platen 31, and when the head abutting mechanism operates, the print head 32 is energized towards the platen 31 to abut against the platen 31.

The ink ribbon supply device 27 mainly has a ribbon holding shaft 35, a ribbon winding shaft 36, a ribbon measurement sensor 34 and a guide frame 37. An unused ink ribbon 30 is wound around the ribbon holding shaft 35 in a roll shape. The ink ribbon 30 after printing is wound around the ribbon winding shaft 36. The ribbon winding shaft 36 is rotated by a ribbon winding motor 53 (refer to FIG. 4) in a direction to wind the ink ribbon (i.e., clockwise direction in FIG. 2) to wind the ink ribbon 30 at a speed higher than the conveyance speed of the ink ribbon by the platen 31. The ribbon winding shaft 36 rotates at the speed higher than the conveyance speed of the ink ribbon, thereby applying a tension to the conveyed ink ribbon 30. The difference between the conveyance speed of the ink ribbon 30 and the speed of the ribbon winding shaft 36 is absorbed by a torque limiter, for example. The ribbon measurement sensor 34 measures the length in the width direction of the ink ribbon 30 pulled out (i.e., the length in the direction orthogonal to the conveyance direction of the ink ribbon 30). The ribbon measurement sensor 34 is also a sensor for detecting a ribbon end, i.e., an end of the ink ribbon 30.

The guide frame 37 is provided with a guide shaft 38 for guiding the ink ribbon 30 pulled out from the ribbon holding shaft 35 at an end thereof on the ribbon holding shaft 35 side. The guide frame 37 is provided with a guide shaft 39 for guiding the ink ribbon 30 to the ribbon winding shaft 36 at an end thereof on the ribbon winding shaft 36 side. In other words, the guide shaft 38 and the guide shaft 39 are provided on the conveyance path 28 of the ink ribbon 30 between the ribbon holding shaft 35 and the ribbon winding shaft 36. The ink ribbon 30 is stretched over a pair of guide shafts 38 and 39 provided in this manner.

After contacting the guide shaft 38, the ink ribbon 30 before printing reaches a position where the print head 32 and the platen 31 abut against each other (i.e., a transfer position or a printing position) after passing through a measurement target region of the ribbon measurement sensor 34, and the ink is transferred onto the label 20a of the label paper 20 simultaneously held by the print head 32. After the transfer, the ink ribbon 30 abuts against the guide shaft 39, and is then wound around the ribbon winding shaft 36 to be collected.

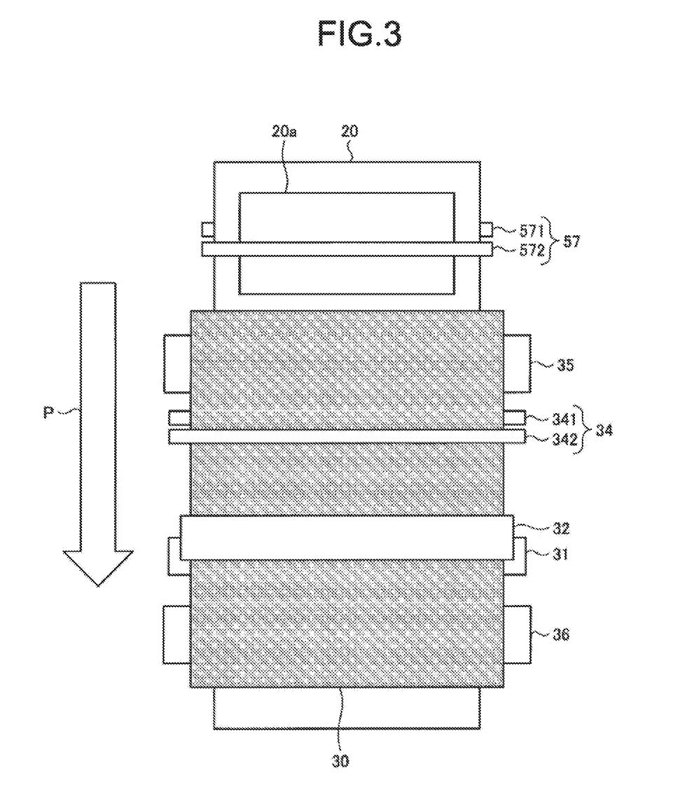

Next, a positional relationship between the ribbon measurement sensor 34, the paper measurement sensor 57, the label paper and the ink ribbon 30 is described. FIG. 3 is a diagram illustrating the positional relationship between the label paper 20 and the paper measurement sensor 57 in the printer, and the positional relationship between the ink ribbon and the ribbon measurement sensor 34. The components described in FIG. 3 are used to show a mutual positional relationship, and the arrangement relationship thereof does not necessarily coincide with that of the respective components shown in FIG. 2. As shown in FIG. 3, the label paper 20 pulled out from the paper holding section 21 is conveyed in a direction indicated by an arrow P at a speed equal to the rotation speed of the platen 31. The ink ribbon 30 pulled out from the ribbon holding shaft 35 is conveyed in the direction indicated by the arrow P according to the rotation speed of the platen 31. The print head 32 applies heat to the sandwiched ink ribbon 30 and the ink melted due to the heat is transferred onto the label paper 20 sandwiched at the same time, thereby performing printing on the label paper 20.

In the vicinity of the ink ribbon 30, the ribbon measurement sensor 34 is provided. The ribbon measurement sensor 34 is a sensor for measuring a length in the width direction of the ink ribbon 30 pulled out (i.e., the length in the direction orthogonal to the conveyance direction of the ink ribbon 30). The ribbon measurement sensor 34 has a ribbon light emitter 341 and a ribbon light receiver 342. In the ribbon light emitter 341, light emitters (not shown) are arranged in a line (e.g., straight line) in the width direction of the ink ribbon 30. The ribbon light emitter 341 faces one surface side of the ink ribbon 30. In the ribbon light receiver 342, light receiving elements (not shown) are arranged in a line (e.g., straight line) in the width direction of the ink ribbon 30. The ribbon light receiver 342 faces the other surface side opposite to the one surface side of the ink ribbon 30. The ribbon light receiver 342 is a sensor that receives the light emitted by the ribbon light emitter 341. The ribbon light receiver 342 at a position where there is the ink ribbon 30 does not receive the light emitted from the ribbon light emitter 341 since the light is blocked by the ink ribbon 30. In other words, the ribbon light receiver 342 corresponding to the length in the width direction of the ink ribbon 30 does not receive the light emitted from the ribbon light emitter 341. The ribbon light receiver 342 at a position where there is no ink ribbon 30 (i.e., located beyond a range between both sides of the ink ribbon 30) receives the light emitted from the ribbon light emitter 341. A total length of all the light receiving elements in the ribbon light receiver 342 which do not receive the light from the ribbon light emitter 341 is measured as a length in the width direction of the ink ribbon 30 in the ribbon light receiver 342. The ribbon measurement sensor 34 measures the length in the width direction of the ink ribbon 30. The ribbon measurement sensor 34 can measure a length in the width direction of any ink ribbon 30 that can be mounted in the printer 1. The ribbon measurement sensor 34 also detects whether there is an ink ribbon using the ribbon light emitter 341 and the ribbon light receiver 342.

In the vicinity of the label paper 20, the paper measurement sensor 57 is provided. The paper measurement sensor 57 is a sensor for measuring a length in the width direction of the label paper 20 pulled out (i.e., the length in the direction orthogonal to the conveyance direction of the label paper 20). The paper measurement sensor 57 has a paper light emitter 571 and a paper light receiver 572. In the paper light emitter 571, light emitters (not shown) are arranged in a line (e.g., straight line) in the width direction of the label paper 20. The paper light emitter 571 faces one surface side of the label paper 20. In the paper light receiver 572, light receiving elements (not shown) are arranged in a line (e.g., straight line) in the width direction of the label paper 20. The paper light receiver 572 faces the other surface side opposite to the one surface side of the label paper 20. The paper light receiver 572 is a sensor that receives the light emitted by the paper light emitter 571. The ribbon light receiver 572 at a position where there is the label paper 20 does not receive the light emitted from the paper light emitter 571 since the light is blocked by the label paper 20. In other words, the paper light receivers 572 corresponding to the length in the width direction of the label paper 20 do not receive the light emitted from the paper light emitter 571. The paper light receiver 572 at a position where there is no label paper 20 (i.e., located beyond a range between both sides of the label paper 20) receives the light emitted from the paper light emitter 571. A total length of all the light receiving elements in the paper light receiver 572 which do not receive the light from the paper light emitter 571 is measured as a length in the width direction of label paper 20 in the paper light receiver 572. The paper measurement sensor 57 measures the length in the width direction of the label paper 20. The paper measurement sensor 57 can measure a length in the width direction of any label paper 20 that can be mounted in the printer 1. The paper measurement sensor 57 also detects whether there is the label paper 20 using the paper light emitter 571 and the paper light receiver 572.

Next, the hardware configuration of the printer 1 is described. FIG. 4 is a block diagram illustrating a hardware configuration of the printer 1. As shown in FIG. 4, the printer 1 includes a CPU (Central Processing Unit) 11, a ROM (Read Only Memory) 12, a RAM (Random Access Memory) 13, a storage device and the like. The CPU 11 executes various programs for controlling the printer 1. The ROM 12 stores the various programs. The RAM 13 temporarily stores copied or decompressed programs and various kinds of data. The storage device 14 stores various programs. The CPU 11, the ROM 12, the RAM 13 and the storage device 14 are connected to each other via a bus 15. The CPU 11, the ROM 12 and the RAM 13 constitute a control section 100. The control section 100 executes a control processing relating to the printer 1 described later by the CPU 11 executing a control program that is stored in the ROM 12 and the storage device 14 and copied or decompressed on the RAM 13.

The RAM 13 has a paper width storage section 131, a ribbon width storage section 132 and a flag storage section 133. The paper width storage section 131 stores the length in the width direction of the label paper 20 measured by the paper measurement sensor 57 described later. The ribbon width storage section 132 stores the length in the width direction of the ink ribbon 30 measured by the ribbon measurement sensor 34 described later. The flag storage section 133 stores a printing processing prohibition flag described later. If the printing processing prohibition flag is “1”, the flag indicates that the printing processing is prohibited. If the printing processing prohibition flag is “0”, the flag indicates that the printing processing is not prohibited.

The storage device 14 is a nonvolatile memory such as an HDD (Hard Disk Drive) or a flash memory that stores storage information even when a power supply is turned off. The storage device 14 includes a control program section 141 and an ink ribbon size section 142. The control program section 141 stores a control program for controlling the printer 1. The ink ribbon size section 142 stores the length in the width direction of the usable ink ribbon 30 in association with the length in the width direction of the label paper 20 to be used.

The control section 100 also controls the display 4, the input device 5, the ribbon winding motor 53, the platen motor 54, the print head 32, the ribbon measurement sensor 34 and the paper measurement sensor 57 via the bus 15.

The display 4 displays an error or a printing prohibition described later, an error indicating no label paper 20 is mounted, an error indicating no ink ribbon 30 is mounted, a message for instructing replacement of a correct ink ribbon and the like. The input device 5 includes operation buttons 6 including the forcible execution key 511. The forcible execution key 511 is a key for forcibly executing the prohibited printing processing. The ribbon winding motor 53 rotates the ribbon winding shaft 36. The platen motor 54 rotates the platen 31. If the platen motor 54 is rotated, the platen 31 rotates to convey the ink ribbon 30 and the label paper 20 in the direction indicated by the arrow P.

In the print head 32, by applying a voltage to the heat generating element, the heat generating element generates heat to melt the ink on the ink ribbon 30 to transfer it onto the label 20a of the label paper 20. In this way, the print head performs printing on the label paper 20. The ribbon measurement sensor 34 includes the ribbon light emitter section 341 and the ribbon light receiver 342, and measures the length in the width direction of the ink ribbon 30. The paper measurement sensor 57 includes the paper light emitter 571 and the paper light receiver 572, and measures the length in the width direction of the label paper 20.

The control section 100 is connected to a communication section 58 via the bus 15. The communication section 58 can communicate with an information processing apparatus (not shown) such as a personal computer via a communication line L. The communication section 58 receives print data to be printed on the label paper 20 from the information processing apparatus. The communication line L may be a wired communication line or a wireless communication line.

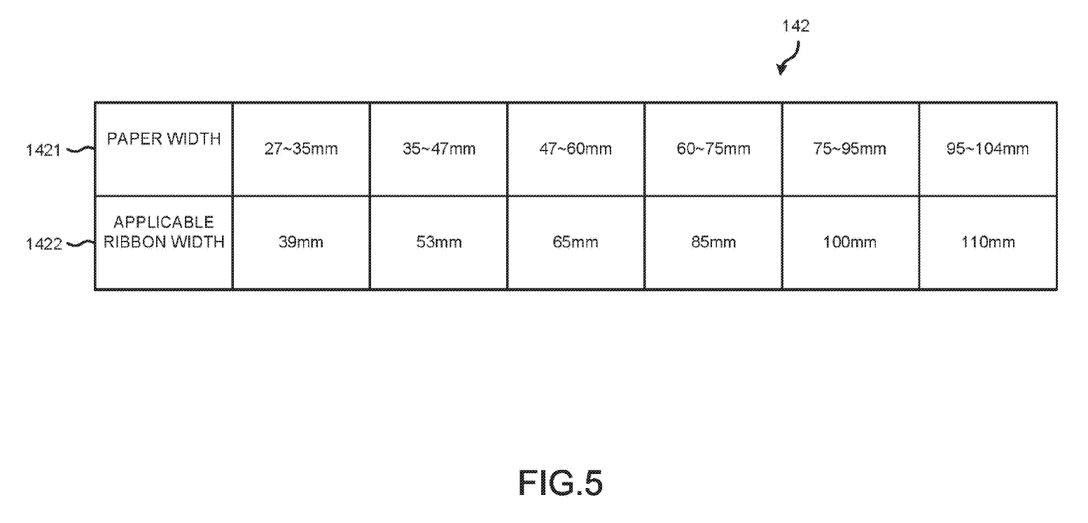

Next, the ink ribbon size section 142 is described with reference to FIG. 5 as an example. The ink ribbon size section 142 stores a table associating a paper width 1421 with an applicable ribbon width 1422. The paper width 1421 indicates the length in the width direction of the label paper 20. In the embodiment, the paper width 1421 indicates, as the length in the width direction of the label paper 20, 27 mm to 35 mm (i.e., equal to or larger than 27 mm and less than 35 mm), 35 mm to 47 mm (i.e., equal to or larger than 35 mm and less than 47 mm), 47 mm to 60 mm (i.e., equal to or larger than 47 mm and less than 60 mm), 60 mm to 75 mm (i.e., equal to or larger than 60 mm and less than 75 mm), 75 mm to 95 mm (i.e., equal to or larger than 75 mm and less than 95 mm) and 95 mm to 104 mm (i.e., equal to or larger than 95 mm and less than 104 mm). Specifically, the label paper 20 of 27 mm to 104 mm can be mounted in the printer 1.

The applicable ribbon width 1422 corresponds to the length in the width direction of the label paper 20, and indicates an appropriate length in the width direction of the ink ribbon 30 in association with the length in the width direction of the label paper 20. In the embodiment, the applicable ribbon width 1422 indicates 39 mm as the length in the width direction of the ink ribbon 30 in association with a length of 27 mm to 35 mm in the width direction of the label paper 20. The applicable ribbon width 1422 indicates 53 mm as the appropriate length in the width direction of the ink ribbon 30 in association with 35 mm to 47 mm which is the length in the width direction of the label paper 20. The applicable ribbon width 1422 indicates 65 mm as the appropriate length in the width direction of the ink ribbon 30 in association with 47 mm to 60 mm which is the length in the width direction of the label paper 20. The applicable ribbon width 1422 indicates 85 mm as the appropriate length in the width direction of the ink ribbon 30 in association with 60 mm to 75 mm which is the length in the width direction of the label paper 20. The applicable ribbon width 1422 indicates 100 mm as the appropriate length in the width direction of the ink ribbon 30 in association with 75 mm to 95 mm which is the length in the width direction of the label paper 20. The applicable ribbon width 1422 indicates 110 mm as the appropriate length in the width direction of the ink ribbon 30 in association with 95 mm to 104 mm which is the length in the width direction of the label paper 20.

This means that the appropriate length in the width direction of the ink ribbon 30 is 39 mm when the length in the width direction of the paper is 27 mm to 35 mm. In other words, when the length in the width direction of the paper is 27 mm to 35 mm, if the length in the width direction of the ink ribbon 30 exceeds 39 mm (39 mm is a predetermined length with respect to the length in the width direction of the label paper 20), the length in the width direction of the ink ribbon 30 is not appropriate for the label paper 20 having 27 mm to 35 mm as the length in the width direction of the label paper 20, and wrinkles easily occur in the ink ribbon 30.

Similarly, when the length in the width direction of the paper is 35 mm to 47 mm, if the length in the width direction of the ink ribbon 30 exceeds 53 mm (53 mm is a predetermined length with respect to the length in the width direction of the label paper 20), the length in the width direction of the ink ribbon 30 is not appropriate. When the length in the width direction of the paper is 47 mm to 60 mm, if the length in the width direction of the ink ribbon 30 exceeds 65 mm (65 mm is a predetermined length with respect to the length in the width direction of the label paper 20), the length in the width direction of the ink ribbon 30 is not appropriate. When the length in the width direction of the paper is 60 mm to 75 mm, if the length in the width direction of the ink ribbon 30 exceeds 85 mm (85 mm is a predetermined length with respect to the length in the width direction of the label paper 20), the length in the width direction of the ink ribbon 30 is not appropriate. When the length in the width direction of the paper is 75 mm to 95 mm, if the length in the width direction of the ink ribbon 30 exceeds 100 mm (100 mm is a predetermined length with respect to the length in the width direction of the label paper 20), the length in the width direction of the ink ribbon 30 is not appropriate. When the length in the width direction of the paper is 95 mm to 104 mm, if the length in the width direction of the ink ribbon 30 exceeds 110 mm (110 mm is a predetermined length with respect to the length in the width direction of the label paper 20), the length in the width direction of the ink ribbon 30 is not appropriate.

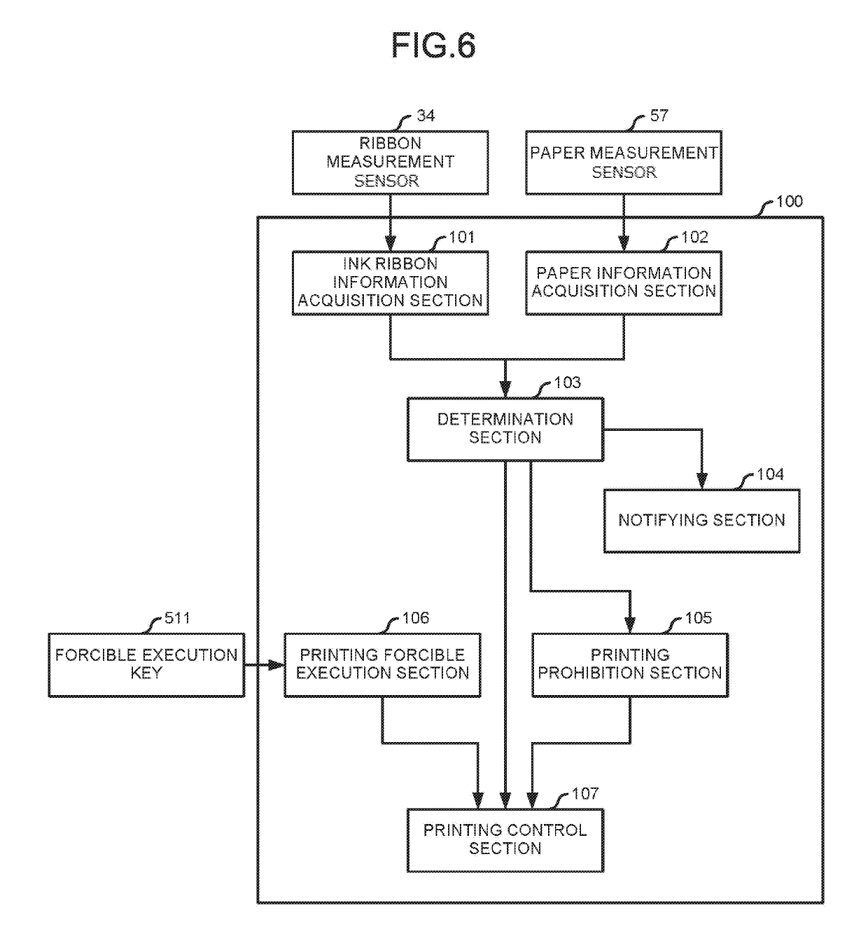

The functional components of the printer 1 are described below. FIG. 6 is a functional block diagram illustrating the functional components of the printer. As shown in FIG. 6, the control section 100 of the printer 1 functions, by executing programs, as an ink ribbon information acquisition section 101, a paper information acquisition section 102, a determination section 103, a notifying section 104, a printing prohibition section 105, a printing forcible execution section 106 and a printing control section 107.

The ink ribbon information acquisition section 101 acquires ink ribbon width information relating to the length in the width direction of the ink ribbon 30 (i.e., width direction orthogonal to the conveyance direction of the ink ribbon 30) measured by the ribbon measurement sensor 34 from the sensor 34. The paper information acquisition section 102 acquires label paper width information relating to the length in the width direction of the label paper 20 (i.e., width direction orthogonal to the conveyance direction of the label paper 20) measured by the paper measurement sensor 57 from the paper measurement sensor 57.

Based on the ink ribbon width information acquired by the ink ribbon information acquisition section 101 and the print medium width information acquired by the paper information acquisition section 102, the determination section 103 determines whether the length in the width direction of the ink ribbon is longer than the predetermined length with respect to the length in the width direction of the print medium. Specifically, based on the acquired ink ribbon width information and the acquired label paper width information, the determination section 103 refers to the ink ribbon size section 142 to compare the ink ribbon width information with the length in the width direction of the ink ribbon stored in the applicable ribbon width 1422 corresponding to the paper width 1421 including the length in the width direction of the label paper 20 indicated by the label paper width information. Then, the determination section 103 determines whether the length in the width direction of the ink ribbon 30 indicated by the ink ribbon width information is the length in the width direction of the ink ribbon stored in the applicable ribbon width 1422, or whether the length in the width direction of the ink ribbon 30 indicated by the ink ribbon width information is longer than the length in the width direction of the ink ribbon stored in the applicable ribbon width 1422. If the length in the width direction of the ink ribbon 30 indicated by the ink ribbon width information is longer than the length in the width direction of the ink ribbon stored in the applicable ribbon width 1422, the determination section 103 determines that the length in the width direction of the ink ribbon 30 indicated by the ink ribbon width information is longer than the predetermined length with respect to the length in the width direction of the label paper 20 stored in the corresponding the paper width 1421.

The printing control section 107 drives the print head 32 based on printing information to perform a printing processing on the print medium if the determination section 103 determines that the length in the width direction of the ink ribbon 30 indicated by the ink ribbon width information is the length in the width direction of the ink ribbon stored in the applicable ribbon width 1422. The communication section 58 receives the printing information from the information processing apparatus.

If the determination section 103 determines that the length in the width direction of the ink ribbon 30 indicated by the ink ribbon width information is longer than the length in the width direction of the ink ribbon stored in the applicable ribbon width 1422, the notifying section 104 displays a message indicating that the mounted ink ribbon 30 is not appropriate for the mounted label paper 20 since there is a possibility of generating wrinkles in the ink ribbon 30 if the ink ribbon 30 and the label paper 20 sandwiched between the print head 32 and the platen 31 are conveyed at the same time.

If the determination section 103 determines that the length in the width direction of the ink ribbon 30 indicated by the ink ribbon width information is longer than the length in the width direction of the ink ribbon stored in the applicable ribbon width 1422, the printing prohibition section 105 controls the printing control section 107 to prohibit printing on the label paper 20 by the print head 32.

When the forcible execution key 511 is operated by an operator, the printing forcible execution section 106 controls the printing control section 107 to forcibly execute the printing prohibited by the printing prohibition section 105. For example, at present, the ink ribbon 30 mounted in the printer 1 is not appropriate for the mounted label paper 20, but if only this ink ribbon is on hand, the forcible execution key 511 is operated according to the determination of the operator.

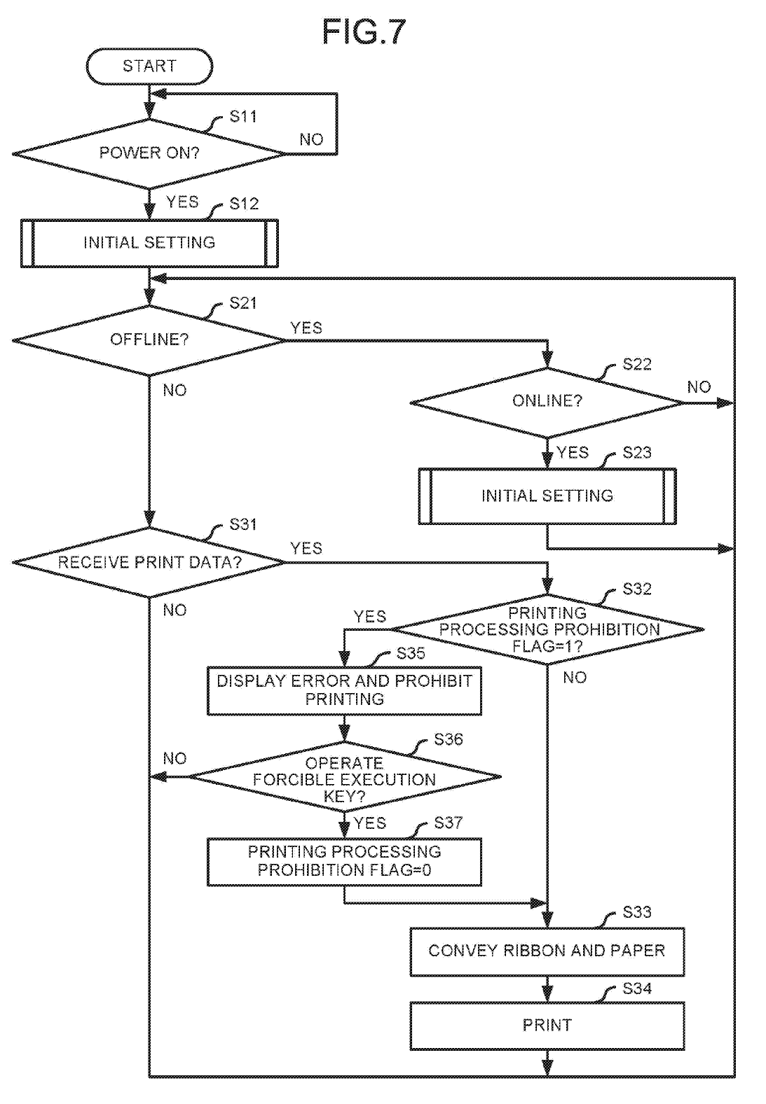

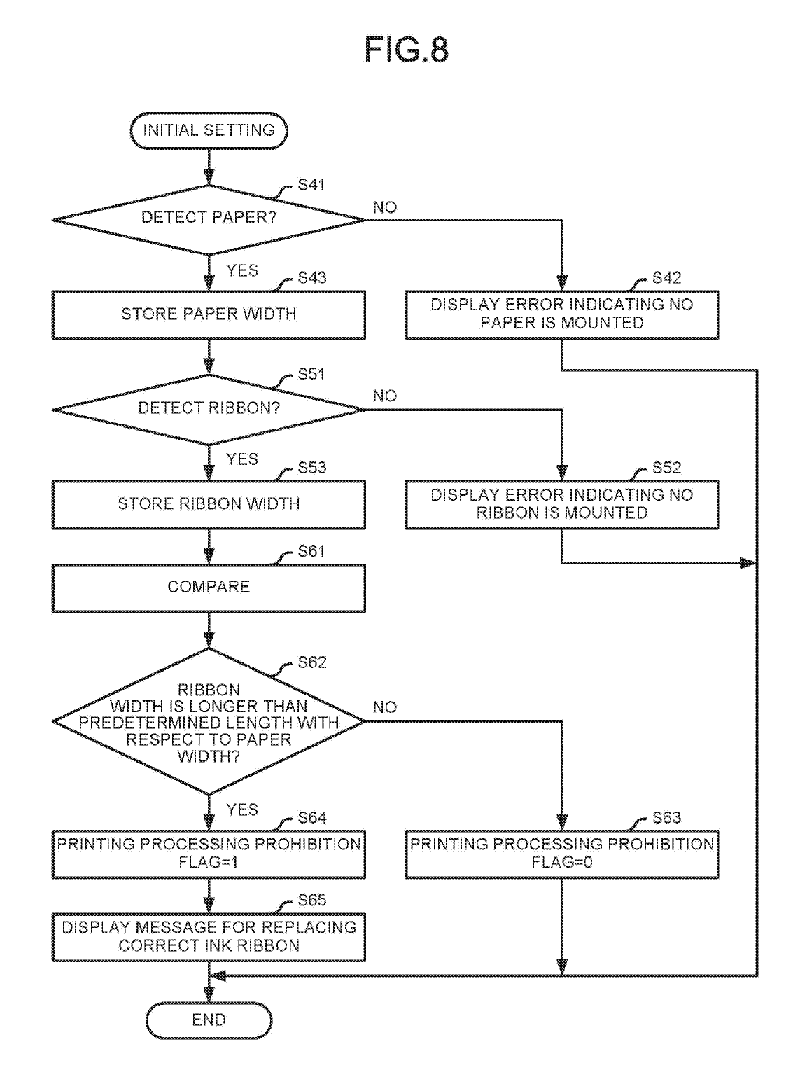

The control processing executed by the printer 1 is described below. FIG. 7 and FIG. 8 are flowcharts depicting a control processing executed by the printer 1. As shown in FIG. 7, the control section 100 of the printer 1 determines whether a power on button of the printer 1 is operated (S11). The control section 100 stands by until it is determined that the power on button is operated (No in S11), contrarily, if it is determined that the power on button is operated (Yes in S11), the control section 100 sets an initial setting shown in FIG. 8 (S12).

Here, with reference to FIG. 8, an initial setting processing executed by the control section 100 in S12 is described. The paper information acquisition section 102 determines whether the paper measurement sensor 57 detects the label paper 20 (S41). If it is determined that the paper measurement sensor 57 detects the label paper 20 (Yes in S41), the paper information acquisition section 102 stores the paper width information acquired from the paper measurement sensor 57 in the paper width storage section 131 (S43).

Next, the ink ribbon information acquisition section 101 determines whether the ribbon measurement sensor 34 detects the ink ribbon 30 (S51). If it is determined that the ribbon measurement sensor 34 detects the ink ribbon 30 (Yes in S51), the ink ribbon information acquisition section 101 stores the ribbon width information acquired from the ribbon measurement sensor 34 in the ribbon width storage section 132 (S53).

Next, the determination section 103 compares the paper width information stored in the paper width storage section 131 with the ribbon width information stored in the ribbon width storage section 132 (S61). Then, the determination section 103 determines whether the length in the width direction of the mounted ink ribbon 30 is appropriate for the length in the width direction of the mounted label paper 20, or whether the length in the width direction of the mounted ink ribbon 30 exceeds the predetermined length with respect to the length in the width direction of the label paper 20 (S62).

If the determination section 103 determines that the length in the width direction of the mounted ink ribbon 30 is appropriate for the length in the width direction of the mounted label paper 20 (No in S62), the control section 100 stores the printing processing prohibition flag “0” in the flag storage section 133 (S63). Then, the control section 100 executes the processing subsequent to S21 described later. On the other hand, if the determination section 103 determines that the length in the width direction of the mounted ink ribbon 30 exceeds the predetermined length with respect to the length in the width direction of the label paper 20 (Yes in S62), the control section 100 stores the printing processing prohibition flag “1” in the flag storage section 133 (S64). Then, the notifying section 104 displays a message on the display 4 indicating that the ink ribbon 30 mounted in the printer 1 is not appropriate for the mounted label paper 20 (S65). Then, the control section 100 executes the processing subsequent to S21 described later.

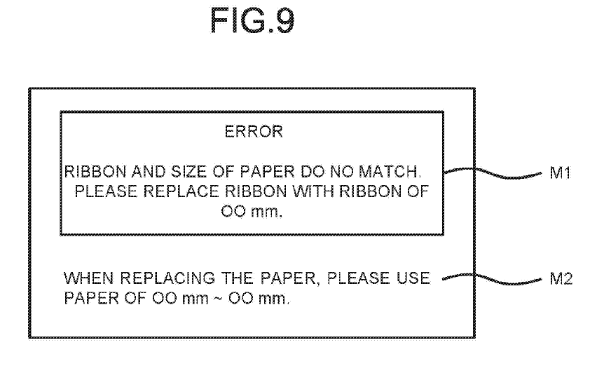

Here, a display example on the display 4 by the notifying section 104 in the processing of S65 is described. FIG. 9 is a diagram illustrating a display example of the printer 1. In FIG. 9, the notifying section 104 controls the display 4 to display a message M1 indicating that the ink ribbon 30 mounted in the printer 1 is not appropriate for the label paper 20 mounted in the printer 1. The notifying section 104 controls the display 4 to display the message M1 indicating the size of the ink ribbon 30 having an appropriate width with respect to the label paper 20 mounted in the printer 1. In addition, the notifying section 104 controls the display 4 to display a message M2 indicating the size of the label paper 20 appropriate for the mounted ink ribbon 30. The operator who sees the display 4 can easily recognize that the ink ribbon 30 having the appropriate width size is not mounted, and can also easily recognize the appropriate width size of the ink ribbon 30 and.

In FIG. 8, if it is determined that the paper measurement sensor 57 does not detect the label paper 20 (No in S41), the control section 100 controls the display 4 to display an error message indicating no label paper 20 is mounted in the printer 1 on the display 4 (S42). Then, the control section 100 executes the processing subsequent to S21 described later. If it is determined that the ribbon measurement sensor 34 does not detect the ink ribbon 30 (No in S51), the control section 100 controls the display 4 to display an error message indicating no ink ribbon 30 is mounted in the printer 1 on the display 4 (S52). Then, the control section 100 executes the processing subsequent to S21 described later.

Return to the description of FIG. 7. Next, the control section 100 determines whether the printer 1 is offline (S21). If it is determined that the printer 1 is offline (Yes in S21), the control section 100 determines whether the printer 1 is online (S22). Since it is predicted that the label paper 20 and the ink ribbon 30 are mounted or replaced if the printer 1 is offline and then is online, if it is determined in S22 that the printer 1 is online (Yes in S22), the control section 100 executes the initial setting again (S23). The initial setting in S23 is the same as that in S12. The control section 100 then returns to the processing in S21. In S22, if it is determined in S22 that the printer 1 is not online (No in S22), the control section 100 returns to the processing in S21.

On the other hand, in S21, if it is determined that the printer 1 is not offline (No in S21), the control section 100 determines whether the communication section 58 receives the print data (S31). If it is determined that the communication section 58 receives the print data (Yes in S31), the control section 100 determines whether the printing processing prohibition flag “1” is stored in the flag storage section 133 (S32). If it is determined that the printing processing prohibition flag “1” is not stored in the flag storage section 133 (i.e., the printing processing prohibition flag “0” is stored in the flag storage section 133) (No in S32), the control section 100 drives the platen motor 54 and the ribbon winding motor 53 to convey the label paper 20 and the ink ribbon 30 in the direction indicated by the arrow P (S33). Then, the printing control section 107 drives the print head 32 based on the print data received by the communication section 58 in S31 to perform printing on the label paper 20 (S34). The control section 100 then returns to the processing in S21.

In S32, if the control section 100 determines that the printing processing prohibition flag “1” is stored in the flag storage section 133 (Yes in S32), the printing prohibition section 105 prohibits driving of the platen motor 54 and the ribbon winding motor 53, or the printing prohibition section 105 prohibits the printing processing based on the print data received by the communication section 58 in S31 (S35). That the printing prohibition section 105 prohibits driving of the platen motor 54 and the ribbon winding motor 53 refers to that the processing for conveying the label paper 20 and the ink ribbon 30 in the direction indicated by the arrow P is not performed by driving the platen motor 54 and the ribbon winding motor 53. That the printing prohibition section 105 prohibits the printing processing based on the print data received by the communication section 58 in S31 refers to that the printing processing for performing printing on the label paper 20 is not performed by driving the print head 32 based on the print data received by the communication section 58. The notifying section 104 displays an error message similar to that in S65 (S35).

Next, the control section 100 determines whether the forcible execution key 511 is operated (S36). If it is determined that the forcible execution key 511 is operated (Yes in S36), the printing forcible execution section 106 stores the printing processing prohibition flag “0” in the flag storage section 133 (S37). Then, the control section 100 forcibly executes the processing in S33 and S34.

If it is determined that the communication section 58 does not receive the print data (No in S31), the control section 100 returns to the processing in S21. If it is determined in S36 that the forcible execution key 511 is not operated (No in S36), the control section 100 returns to the processing in S21. If a power off button (not shown) is operated while the power supply is on, the control section 100 returns to the processing in S11.

As described above, based on the ink ribbon width information acquired by the ink ribbon information acquisition section 101 and the print medium width information acquired by the paper information acquisition section 102, the printer 1 of the present embodiment determines whether the length in the width direction of the ink ribbon 30 is longer than the predetermined length with respect to the length in the width direction of the label paper 20. If it is determined that the length in the width direction of the ink ribbon 30 is longer than the predetermined length with respect to the length in the width direction of the label paper 20, the printer 1 notifies a message indicating that the ink ribbon 30 is not appropriate for the label paper 20. Since the operator of the printer 1 who sees the message can use the printer 1 after mounting the ink ribbon 30 appropriate for the mounted label paper 20, it is possible to prevent the wrinkles from occurring in the ink ribbon when the ink ribbon is conveyed.

According to the embodiment, if it is determined that the length in the width direction of the ink ribbon 30 is longer than the predetermined length with respect to the length in the width direction of the label paper 20, the printing by the printing control section 107 is prohibited. Therefore, the printer 1 does not execute the printing process using the ink ribbon 30 that is not appropriate for the mounted label paper 20.

According to the embodiment, if the forcible execution key 511 is operated, even when printing is prohibited, the printing processing is executed. Therefore, for example, if there is only the ink ribbon 30 that is not appropriate for the mounted label paper 20, the printing processing can be executed using the inappropriate ink ribbon 30.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, in the embodiment, a thermal printer is described as an example of the printer 1. However, the present invention may be applicable to a printer other than the thermal printer as long as it is a printer that performs the printing processing by sandwiching the ink ribbon and the print medium between the platen and the print head.

In the embodiment, as the printer, the printer 1 that performs printing on the label paper 20 is described as an example. However, the printer may perform printing on a paper (for example, receipt paper) other than the label paper 20.

In the embodiment, the ribbon measurement sensor 34 is a transmission type sensor. The paper measurement sensor 57 is a transmission type sensor. However, both or either one of the above sensors may be a reflection type sensor.

In the embodiment, the ink ribbon information acquisition section 101 acquires the length in the width direction of the ink ribbon 30 measured by the sensor 34; however, it is not limited to that. For example, the ink ribbon information acquisition section 101 may acquire the length in the width direction of the ink ribbon 30 that is stored in advance. In the embodiment, the paper information acquisition section 102 acquires the length in the width direction of the label paper 20 measured by the sensor 57; however, it is not limited to that. For example, the paper information acquisition section 102 may acquire the length in the width direction of the label paper 20 that is stored in advance.

The program executed by the printer 1 according to the embodiment is provided by being recorded in a computer-readable recording medium such as CD-ROM (Compact Disc Read-Only Memory), an FD (Flexible Disk), a CD-R (Compact Disc Rewritable) and a DVD (Digital Versatile Disk) in a file of an installable format or an executable format.

The program executed by the printer 1 of the embodiment may be stored on a computer connected to a network such as the Internet and provided by being downloaded via the network. The program executed by the printer 1 according to the embodiment may be provided or distributed via the network such as the Internet.

The program executed by the printer according to the embodiment may be provided by being incorporated in a ROM or the like in advance.

What is claimed is:

1. A printer comprising:
a line-shaped print head configured to transfer ink held on an ink ribbon onto a print medium;
a platen configured to convey the print medium and the ink ribbon such that the print medium and the ink ribbon are sandwiched between the platen and the print head;
a first sensor configured to detect a width of the print medium;
a second sensor configured to detect a width of the ink ribbon;
a display; and
a processor configured to
determine whether the width of the ink ribbon detected by the second sensor exceeds a maximum width, which is set in accordance with the width of the print medium detected by the first sensor, and
control the display to display a message indicating that the ink ribbon is not appropriate when it is determined that the width of the ink ribbon exceeds the maximum width.

2. The printer according to claim 1, wherein
the processor does not execute printing processing when it is determined that the width of the ink ribbon exceeds the maximum width.

3. The printer according to claim 2, further comprising:
an input device, wherein
in response to a predetermined operation input through the input device, the processor executes the printing processing even when it is determined that the width of the ink ribbon exceeds the maximum width.

4. The printer according to claim 1, wherein
the message indicates an appropriate size of an ink ribbon corresponding to the detected print medium.

5. The printer according to claim 1, wherein
the first sensor is further configured to detect a presence of the print medium, and
the processor controls the display to display a message indicating that no print medium is set when the presence of the print medium is not detected.

6. The printer according to claim 1,
the second sensor is further configured to detect a presence of the ink ribbon, and
the processor controls the display to display a message indicating that no ink ribbon is set when the presence of the ink ribbon is not detected.

7. The printer according to claim 1, wherein
the first sensor comprises a plurality of light emitters and respective receivers arranged along a width direction of the print medium such that the print medium is conveyed between the emitters and receivers.

8. The printer according to claim 1, wherein
the second sensor comprises a plurality of light emitters and respective receivers arranged along a width direction of the ink ribbon such that the ink ribbon is conveyed between the emitters and receivers.

9. The printer according to claim 1, wherein
the print medium is a label.

10. The printer according to claim 1, wherein
the controller performs the determination and message display when the printer is turned on.

11. A method carried out by a printer, the method comprising:
conveying, by a platen, a print medium and an ink ribbon;
detecting, by a first sensor, a width of the print medium;
detecting, by a second sensor, a width of the ink ribbon;
determining whether the width of the ink ribbon detected by the second sensor exceeds a maximum width, which is set in accordance with the width of the print medium detected by the first sensor; and
displaying on a display a message indicating that the ink ribbon is not appropriate when it is determined that the width of the ink ribbon exceeds the maximum width.

12. The method according to claim 11, further comprising:
stopping printing processing when it is determined that the width of the ink ribbon exceeds the maximum width.

13. The method according to claim 12, further comprising:
receiving, through an input device, a predetermined operation, and
in response to the predetermined operation, executing the printing processing even when it is determined that the width of the ink ribbon exceeds the maximum width.

14. The method according to claim 11, wherein
the message indicates an appropriate size of an ink ribbon corresponding to the detected print medium.

15. The method according to claim 11, further comprising:
detecting, by the first sensor, a presence of the print medium, and
displaying a message indicating that no print medium is set when the presence of the print medium is not detected.

16. The method according to claim 11, further comprising:
detecting, by the second sensor, a presence of the ink ribbon, and
displaying a message indicating that no ink ribbon is set when the presence of the ink ribbon is not detected.

17. The method according to claim 11, wherein
the first sensor comprises a plurality of light emitters and respective receivers arranged along a width direction of the print medium such that the print medium is conveyed between the emitters and receivers.

18. The method according to claim 11, wherein
the second sensor comprises a plurality of light emitters and respective receivers arranged along a width direction of the ink ribbon such that the ink ribbon is conveyed between the emitters and receivers.

19. The method according to claim 11, wherein
the print medium is a label.

20. A non-transitory computer readable medium storing a program causing a computer to execute a method comprising:
conveying, by a platen, a print medium and an ink ribbon;
detecting, by a first sensor, a width of the print medium;
detecting, by a second sensor, a width of the ink ribbon;
determining whether the width of the ink ribbon detected by the second sensor exceeds a maximum width, which is set in accordance with the width of the print medium detected by the first sensor; and
displaying on a display a message indicating that the ink ribbon is not appropriate when it is determined that the width of the ink ribbon exceeds the maximum width.
